(19) United States
(12) Patent Application Publication
(10) Pub. No.: US 2025/0217606 A1
(43) Pub. Date: Jul. 3, 2025

(54) SWITCHED-CAPACITOR CASCADED MATRIX MULTIPLIER WITH VARIABLE INPUT BIT RESOLUTION

(71) Applicant: Reconceive AI, Inc., San Carlos, CA (US)

(72) Inventors: Jorge A. Grilo, Berkeley, CA (US); Ronald E. Gagnon, JR., Berkeley, CA (US)

(21) Appl. No.: 19/004,165

(22) Filed: Dec. 27, 2024

Related U.S. Application Data
(60) Provisional application No. 63/615,226, filed on Dec. 27, 2023.

(51) Int. Cl. G06G 7/32

(52) U.S. Cl. CPC G06G 7/32

(57) ABSTRACT

A capacitive multiplier includes, in part, a multitude of capacitors disposed along S rows and T columns. The capacitors disposed in the ith column are coupled to one another and are configured to be coupled to or uncoupled from capacitors disposed in the column T via an ith switch, where i ranges from 1 to (T-1). The capacitive multiplier further includes, in part, a timing controller configured to generate (T-1) control signals each of which is associated with one of (T-1) switches. The timing controller generates the (T-1) control signals in sequence such that the ith switch is closed before (i+1)th switch opens, and the ith switch is opened before closing the (i+1)th switch. In response to closing of the ith switch, the capacitors in the ith column are coupled to capacitors in column T to share and distribute their charges.

### RELATED APPLICATION

The present application claims benefit under 35 USC 119(e) of U.S. Patent Application No. 63/615,226, filed Dec. 27, 2023, the content of which is incorporated herein by reference in its entirety.

### BACKGROUND

A key part in artificial intelligence and machine learning is the computationally intensive task of matrix multiplication. Matrix multiplication or matrix product is a mathematical operation that produces a matrix from two matrices with entries in a field, or, more generally, in a ring or even a semi-ring. The matrix product is designed for representing the composition of linear maps that are represented by matrices. Matrix multiplication is thus a basic tool of linear algebra, and as such has numerous applications in many areas of mathematics, as well as in applied mathematics, statistics, physics, economics, and engineering. In more detail, if A is an n×m matrix and B is an m×p matrix, their matrix product AB is an n×p matrix, in which the m entries across a row of A are multiplied with the m entries down a column of B and summed to produce an entry of AB. When two linear maps are represented by matrices, then the matrix product represents the composition of the two maps.

Computing matrix products is a central operation in all computational applications of linear algebra. Its computational complexity is O(n³) (for n×n matrices) for the basic algorithm (this complexity is O(n^{2.373}) for the asymptotically fastest known algorithm). This nonlinear complexity means that matrix product is often the critical part of many algorithms. This is enforced by the fact that many operations on matrices, such as matrix inversion, determinant, solving systems of linear equations, have the same complexity. Therefore various algorithms have been devised for computing products of large matrices, taking into account the architecture of computers.

Matrix multiplication is at the heart of all machine learning algorithms and is the most computationally expensive task in these applications. Machine learning implementations may use general-purpose CPUs and perform matrix multiplications in serial fashion. The serial computations in the digital domain together with limited memory bandwidth sets a limit on maximum throughput and power efficiency of the computing system.

### BRIEF DESCRIPTION OF THE DRAWINGS

The following Detailed Description, Figures, and appended Claims signify the nature and advantages of the innovations, embodiments and/or examples of the claimed inventions. All of the Figures signify innovations, embodiments, and/or examples of the claimed inventions for purposes of illustration only and do not limit the scope of the claimed inventions. Such Figures are not necessarily drawn to scale, and are part of the Disclosure.

FIG. 1 is a top-level schematic view of a multiplier, in accordance with one embodiment of the present disclosure.

FIG. 2 is an example of multiplying bit cell used in an array, in accordance with one embodiment of the present disclosure.

FIG. 3 is a schematic diagram of a capacitive multiplier array, in accordance with one embodiments of the present disclosure.

FIG. 4 is a timing diagram of a number of signals associated with the capacitive multiplier array of FIG. 3, in accordance with one embodiments of the present disclosure.

FIG. 5 is a timing diagram of a number of signals associated with the capacitive multiplier array of FIG. 3, in accordance with one embodiments of the present disclosure.

### DETAILED DESCRIPTION

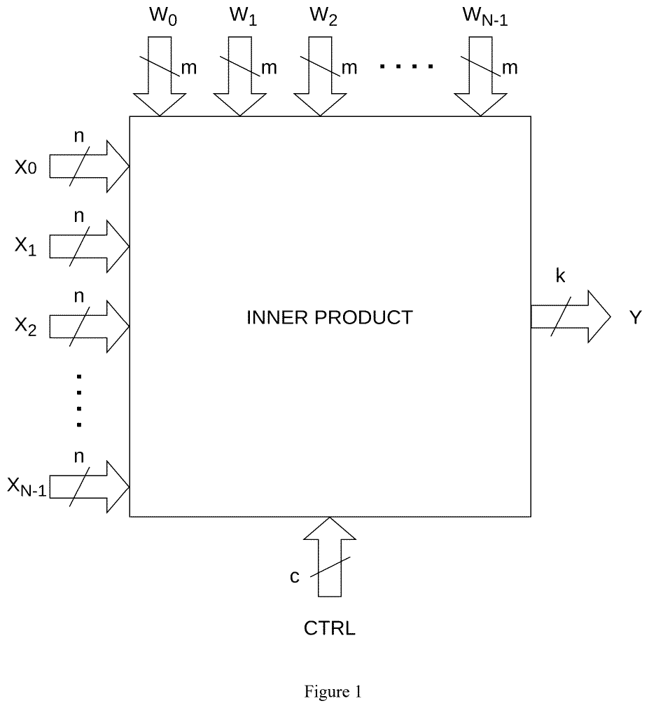

A switched capacitor vector-dot product (VDP) engine, referred to herein as a VDP engine or VDP, as depicted in FIG. 1, includes, in part, a multitude of VDP units in parallel each receiving the same X input. Each VDP unit also receives a unique W inputs, thus constituting a matrix multiplier. The VDP is a matrix multiplier that performs a bitwise multiply and accumulate function, as described further below.

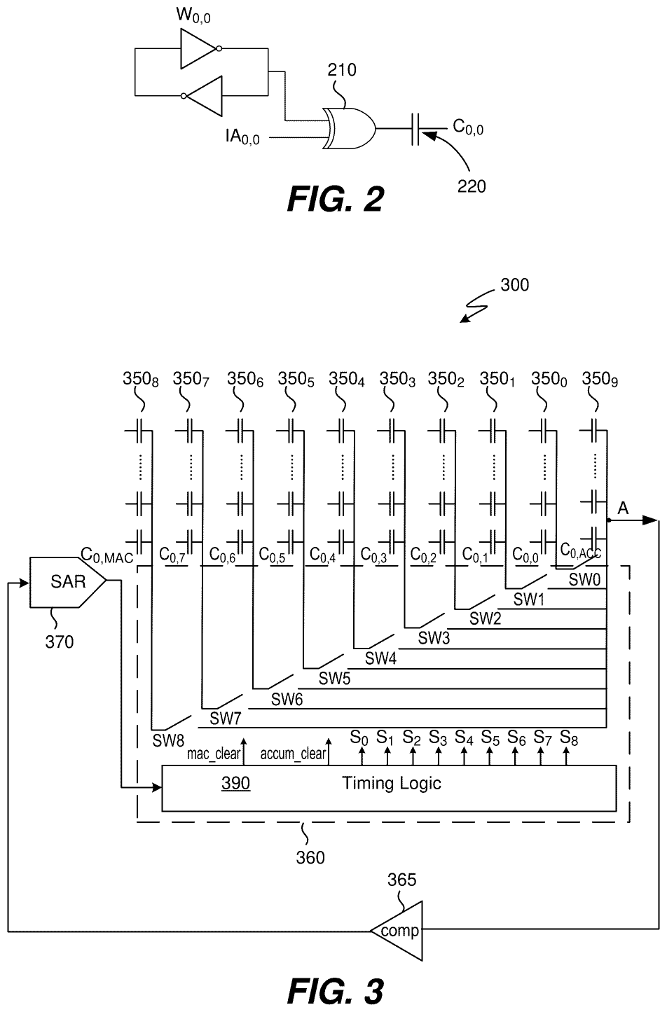

The X and W inputs can be of variable bit-depth, i.e. 8 bits, 4 bits, 3 bits, and the like. The VDP includes a multitude of sub-circuits, as shown in FIG. 2. The size of the VDP is determined by the bit-depth of the W inputs identified herein as m. There are N X inputs each with a bit-depth identified herein as n. Both m and N may be defined by the application requirements for the maximum bit-depth W input being used, and maximum number of inputs. Each row of the VDP defines a single m-depth input W, arranged column-wise in the array. The number of rows is defined by N.

The W inputs are loaded into the cross-coupled inverters and stored for computation, as shown in the exemplary FIG. 2. The input X (shown as IA_{0,0}) is shifted bit-serial into the array to multiply with all of the W bits in parallel using associated XOR gate 210. The resulting multiplication drives a capacitor 220 as shown in FIG. 2.

FIG. 3 is a schematic diagram of capacitive multiplier array 300 in accordance with some examples. Exemplary array 300 is shown as including 10 arrays of capacitors 350₀-350₉. It is understood that the array may have any number of rows and columns. Columns 350₀-350₇ are associated with the e.g. 8-bit data multiplication in this example The capacitor for each cell in FIG. 2 is connected column-wise as shown in FIG. 3. In the example shown in FIG. 3, for each bit of a weight W, the charges associated with the multiplication are stored in capacitors C_{0,0}-C_{0,7}, as described further below.

In array 300, each column is shown as including N capacitors in parallel. In order to accumulate across the bit-wise depth of W, the columns 350₀-350₇ are successively connected through switch matrix 360. There are two additional columns of capacitors disposed at the each end of the array, namely column 350₉ positioned to the right of column 350₀, and column 350₈ positioned to the left of column 350₇. The capacitors in array 350₉ store the accumulated results as the switching network 360 operates across the array.

Column 350₀-350₈ are controlled so as to be coupled to or uncoupled from node A by associated switches SW0-SW8 respectively, which in turn, are controlled by the timing logic 390. For example, when switch SW0 is caused to close by timing logic 390, the capacitors in column 350₀ are coupled to node A to share and distribute the charges. Capacitors in column 350₉ are directly coupled to node A.

The signals S₀-S₈, mac_clear, and accum_clear supplied by timing logic 390, are used to control switches SW0-SW8 of the capacitor array 300. To perform the accumulation column-wise and across the array, the switches are closed and opened in order, thus sharing their charge with the capacitors disposed in array 350₉. For example, when SW0 is closed, the charge in the capacitors of column 350₀ is shared with the capacitors in column 350₉. As the capacitors in columns 350₀ and 350₉ have the same capacitance, the charge is divided equally between them. After the charge distribution between the capacitors in columns 350₀ and 350₉, switch SW0 is opened and switch SW1 is closed. Accordingly, the charges of the capacitors in column 350₁ and column 350₉ are redistributed. The charges of capacitors in columns 350₁ and 350₉ are both halved, with column 350₁ holding the charge from bit 1 of the array 300, and column 350₉ holding half the charge of column 350₀, which is further divided by 2. The closing and opening of the switches continues until the final result of the multiplication is achieved in column 350₉ by closing switch SW8. After SW8 is opened, the result of the multiplication at node A of column 350₉ is supplied to comparator 365. The output of comparator 365, which is either a logic 1 or 0, is supplied to SAR 370 whose output provides an additional signal to timing logic 390.

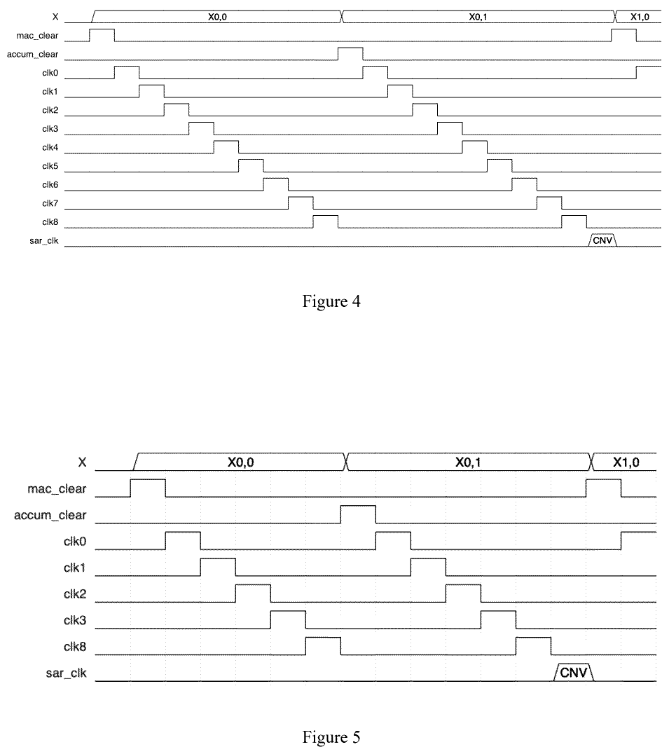

The timing diagram for an 8-bit W being multiplied by a 2-bit X is shown in FIG. 4. The sequence starts by loading in bit 0 of the X input, and resetting all of the capacitors in the array through signal mac_clear. The SW0-8 are then successively closed and opened across the array to accumulate and scale the multiplication results. Once the bit 0 of the X input has been multiplied and accumulated across W, capacitors in columns 350₀-350₉ are reset using signal accum_clear. The most significant bit (MSB) of column 350₉ is not reset as it is storing the result of X0 multiplied by W0-7. The sequence of successively closing and opening SW0-8 begins again.

When SW8 is closed the second time, the charge stored on the MSB from the X0 multiplication with W0-7 is halved to scale it appropriately, while being added to the result of X1 multiplied with W0-7. This final result is stored on the MSB of column 350₉ and then delivered to the SAR ADC for conversion to the digital domain. With the conversion complete, the entire MAC array is reset through mac_clear while the next N inputs of X value is shifted in to begin its MAC function, starting with bit 0. There is no constraint on the number of bits shifted in for each X input. Shown in FIG. 4 are 2 bits, but it can extend to any bit-depth needed, as the result is accumulated on C0,MSB until the entire mac is cleared.

The timing network is flexible as shown in FIG. 5. For example, to multiply just 4b W input with a 2b X input, the timing pattern would be configured as shown in FIG. 5. The same array as shown in FIG. 3 would be used, but the capacitor arrays C4-C7 would be ignored. This allows for variable bit depth resolution with the W input. The accum_clear signal, in FIG. 5, can be realized as a bus, going to each SW0-8, and being able to reset each capacitor column independent of the others. In FIG. 5, capacitor arrays C4-C7 can then be held in reset continuously, or simply ignored, while the MAC operation is performed on C0-C3.

As described above, C4-C7 could be ignored, but they can store another W input that is 4b deep. The input X could be cycled through again, or another input X entirely could be shifted in, going through the same operation shown in FIG. 5, but this time C0-C3 are ignored and C4-C7 are utilized, but the consequence is that 2 MAC operations can happen serially by loading two weight values together, and configuring through the timing network, accum_clear, and mac_clear signals, which capacitor columns are accumulated onto the charge from all the capacitor columns are accumulated on column 390₉.

The flexibility in how the array can be configured and operated advantageously provides enhanced efficiency in performing MAC operations. The sequence, size, and order of the MAC operations may be arbitrarily configured by the timing logic shown in FIG. 3.

What is claimed is:

1. A capacitive multiplier comprising:
a plurality of capacitors disposed along S rows and T columns, wherein capacitors disposed in i^{th} column are coupled to one another and are configured to be coupled to or uncoupled from capacitors disposed in the column T via an i^{th} switch; wherein i ranges from 1 to (T-1);
a timing controller configured to generate (T-1) control signals each associated with a different one of (T-1) switches, wherein the timing controller generates the (T-1) control signals in sequence such that the i^{th} switch is closed before (i+1)^{th} switch, and the i^{th} switch is opened before closing the (i+1)^{th} switch, wherein in response to closing of the i^{th} switch capacitors in the i^{th} column are coupled to capacitors in column T to share and distribute their charges, wherein S and T are integer numbers.
